(19) United States
(12) Patent Application Publication
(10) Pub. No.: US 2015/0365728 A1
(43) Pub. Date: Dec. 17, 2015

(54) DISPLAY SYSTEM AND PROGRAM SELECTION METHOD THEREOF

(71) Applicant: National Taiwan University, Taipei (TW)

(72) Inventors: Ming-Te Lu, Taipei City (TW); Jenn-Feng Li, Taipei City (TW); Yong-Yuan Shen, Taipei City (TW)

(21) Appl. No.: 14/512,481

(22) Filed: Oct. 13, 2014

(30) Foreign Application Priority Data
Jun. 13, 2014 (TW) 103120574

(51) Int. Cl. H04N 21/466; H04N 21/41; H04N 21/422; H04N 21/4415; G06K 9/00; H04N 21/84

(52) U.S. Cl. CPC H04N 21/4667; G06K 9/00221; H04N 21/84; H04N 21/4668; H04N 21/42209; H04N 21/4415; H04N 21/4126

(57) ABSTRACT

A display system and a program selection method thereof are provided. In the method, an image including at least one viewer in a viewing area of the display system is captured by using an image capturing unit and accordingly at least one viewer identification is produced. A connection between the display system and the portable device of each viewer is established by using the viewer identification, and a program list is transmitted to the connected portable devices, so that each portable device evaluates a plurality of programs in the program list according to a preference record of the viewer and sends an evaluation result back to the display system. Finally, the evaluation result of each portable device is received, and all of the evaluation results are gathered to calculate statistics, so as to select the program to be played.

### CROSS-REFERENCE TO RELATED APPLICATION

This application claims the priority benefit of Taiwan application serial no. 103120574, filed on Jun. 13, 2014. The entirety of the above-mentioned patent application is hereby incorporated by reference herein and made a part of this specification.

### BACKGROUND OF THE INVENTION

1. Field of the Invention

The invention relates to a system and a method for displaying programs, and more particularly, relates to a display system and a program selection method thereof.

2. Description of Related Art

Many sensing devices have been introduced to new smart televisions for controlling display of television contents. For example, by combining gesture sensing devices with televisions, viewers are able to switch television channels through gestures. Or, by combining video cameras with the televisions, an image of the viewers watching the television may be captured, and face recognition may be performed on the viewers in the image, so as to recommend programs according to preferences of the viewers.

Although these new operating methods may provide the viewers with a whole new television usage experience, in reality, switching the channels one by one through the gestures appears to be inefficient when there are too many television programs to choose from. Even if a television is capable of selecting the programs through the face recognition, such selection may only be done according to a history record of specific viewers who watched the television before instead of new viewers. In case multiple viewers are watching the television at the same time, the television cannot integratedly take in consideration of viewing preferences of different viewers so as to provide the program suitable for all of the viewers.

### SUMMARY OF THE INVENTION

The invention is directed to a display system and a program selection method thereof capable of selecting suitable program according to preferences of viewers watching the television.

The program selection method of the invention is adapted for a display system having an image capturing unit. In the method, an image including at least one viewer in a viewing area of the display system is captured by using an image capturing unit and at least one viewer identification is produced according to the image. A connection between the display system and the portable device of each viewer is established by using the viewer identification, and a program list is transmitted to the connected portable devices, so that each portable device evaluates a plurality of programs in the program list according to a preference record of the viewer and sends an evaluation result back to the display system. Finally, the evaluation result of each portable device is received, and all of the evaluation results are gathered to calculate statistics, so as to select the program to be played.

In an embodiment of the invention, the step of producing the viewer identification according to the image includes identifying each of the viewers included in the image, and capturing a personal image of each of the viewers to serve as the viewer identification.

In an embodiment of the invention, the step of producing the viewer identification according to the image includes analyzing the image for obtaining characteristic information of each of the viewers included in the image to serve as the viewer identification.

In an embodiment of the invention, the step of establishing the connection between the display system and the portable device of each viewer by using the viewer identification includes transmitting the viewer identification to each of the portable devices, in which each of the portable devices performs a verification to verify the received viewer identification with the viewer identification of the portable device, and establishes the connection with the display system if the verification is passed.

In an embodiment of the invention, the step of establishing the connection between the display system and the portable device of each viewer by using the viewer identification includes receiving the viewer identification provided by each of the portable devices, performing a verification to verify the received viewer identification with the viewer identification produced previously, and establishing the connection with the portable device if the verification is passed.

In an embodiment of the invention, before the step of each of the portable devices evaluating the programs in the program list according to the preference record of the viewer who owns the portable device, the method further includes following steps. Each of the portable devices establishes a personal preference database of the viewer who owns the portable device, in which the personal preference database records a plurality of entertainment categories and a preference strength of each of the entertainment categories. The portable device updates the preference strength of each of the entertainment categories according to a record of the viewer using applications on the portable device, a record of the viewer accessing media information on the portable device, and a usage record of the personal preference database.

In an embodiment of the invention, the step of the portable device updating the preference strength of each of the entertainment categories according to the record of the viewer accessing the media information on the portable device includes analyzing a file characteristic of the accessed media information, and updating the preference strength of each of the entertainment categories according to the file characteristic.

In an embodiment of the invention, the step of gathering all of the evaluation results to calculate statistics, and accordingly selecting the program to be played includes sorting the programs according to an evaluation score of each of the programs, and providing a recommendation list including the sorted programs.

A display system of the invention includes an image capturing unit, a connection unit and a processing unit. The image capturing unit captures an image including at least one viewer in a viewing area of the display system. The connection unit establishes a connection between the display system and a portable device of each viewer. The processing unit is coupled to the display unit, the image capturing unit and the connection unit. The processing unit is configured to produce at least one viewer identification according to the image captured by the image capturing unit, establish the connection between the display system and the portable devices through the connection unit by using the viewer identification, transmit a program list to the connected portable devices, and receive an evaluation result for the program list sent by each of the portable devices, gathers all of the evaluation results to calculate statistics, and accordingly selects the program to be played.

In an embodiment of the invention, the display system further includes a display unit, which is coupled to the processing unit and configured to display the program selected by the processing unit.

In an embodiment of the invention, the processing unit includes identifying each of the viewers included in the image captured by the image capturing unit, and capturing a personal image of each of the viewers to serve as the viewer identification.

In an embodiment of the invention, the processing unit includes analyzing the image captured by the image capturing unit for obtaining characteristic information of each of the viewers included in the image to serve as the viewer identification.

In an embodiment of the invention, the processing unit includes transmitting the viewer identification to each of the portable devices through the connection unit, wherein each of the portable devices performs a verification to verify the received viewer identification with the viewer identification of the portable device and establishes the connection between the display system and the portable device if the verification is passed.

In an embodiment of the invention, the processing unit includes receiving the viewer identification provided by each of the portable devices through the connection unit, performing a verification to verify the received viewer identification with the viewer identification produced previously, and establishing the connection between the display system and the portable device if the verification is passed.

In an embodiment of the invention, when the program list transmitted by the display system is received, each of the portable devices evaluates a plurality of programs in the program list according to a preference record of the viewer who owns the portable device, and sends the evaluation result back to the display system.

In an embodiment of the invention, each of the portable devices further establishes a personal preference database of the viewer who owns the portable device, wherein the personal preference database records a plurality of entertainment categories and a preference strength of each of the entertainment categories, and the portable device further updates the preference strength of each of the entertainment categories according to a record of the viewer using applications on the portable device, a record of the viewer accessing media information on the portable device, and a usage record of the personal preference database.

In an embodiment of the invention, each of the portable devices further analyzes a file characteristic of the accessed media information, and updates the preference strength of each of the entertainment categories according to the file characteristic.

In an embodiment of the invention, the processing unit sorts the programs according to an evaluation score of each of the programs, and provides a recommendation list including the sorted programs.

Based on above, according to the display system and the program selection method thereof in the invention, the viewers in the viewing area are identified by using image recognition, and the connection with the portable device of each of the viewers is established for providing the program list. After the programs are evaluated by each of portable devices according to the personal preference database established for the viewer, the evaluation results are passed to the display system for counting. Accordingly, the display system is capable of selecting the program which is most suitable for all of the viewers at presence, and thereby recommending and playing the program.

To make the above features and advantages of the disclosure more comprehensible, several embodiments accompanied with drawings are described in detail as follows.

### BRIEF DESCRIPTION OF THE DRAWINGS

FIG. 1A to FIG. 1C are schematic diagrams illustrating a program selection method according to an embodiment of the invention.

FIG. 2 is a block diagram illustrating a display system according to an embodiment of the invention.

FIG. 3 is a flowchart illustrating the program selection method according to an embodiment of the invention.

FIG. 4 is a schematic diagram illustrating establishment of the personal preference database according to an embodiment of the invention.

FIG. 5 is a block diagram illustrating a display system according to an embodiment of the invention.

### DESCRIPTION OF THE EMBODIMENTS

Nowadays, almost every person carries a portable device such as a mobile phone, or a tablet computer, and frequently uses the portable device for executing application or performing operations such as playing media data or accessing media information. Based on a habit of a user in using the application on the portable device and a type of the media information being used, the invention aims to establish a personal preference database of the user on the portable device. Accordingly, when the user is watching a television, a program list of the television may be passed to the portable devices of the viewers on the scene, such that the portable devices may evaluate preferences of the viewers for programs according to records in the personal preference database. And then, the television may gather evaluation results to eventually select the program which is most suitable for all of the viewers.

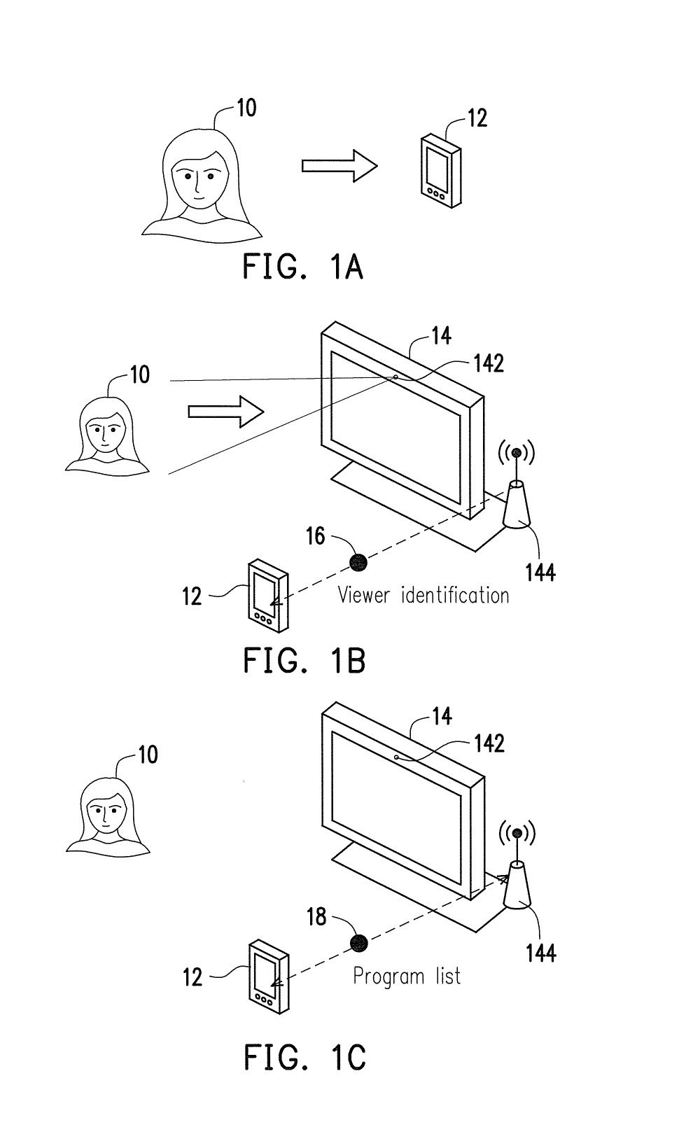

FIG. 1A to FIG. 1C are schematic diagrams illustrating a program selection method according to an embodiment of the invention. Referring to FIG. 1A, in the present embodiment, the habit and the preference of a viewer 10 are gradually established while the viewer is using a portable device 12. The portable device 12 is an electronic device such as a mobile phone, a personal digital assistant, a tablet computer, a notebook computer, or a media player, but a type of the electronic device is not limited to the above. Next, referring to FIG. 1B, while the viewer 10 is watching a display system 14, the display system 14 may capture an image of the viewer through an image capturing device 142 (built-in) to establish a viewer identification 16 accordingly, and transmit the viewer identification 16 to the portable device 12 through a wireless connection device 144 for a verification. The display system 14 of the present embodiment is a television. In other embodiments, the display system 14 may also be a combination of a television and a set-top box, which is not particularly limited by the invention. Referring to FIG. 1C, after the verification is passed, the display system 14 may transmit a program list 18 (including programs which are currently playable) to the portable device 12 through the wireless connection device 144. The portable device 12 may evaluate the programs in the program list 18 according to a preference record of the viewer 10 which is established previously, and send the evaluation result back to the display system 14. Lastly, the display system 14 may gather the evaluation results replied from the portable devices of the viewers on the scene to calculate statistics, and accordingly select the program which is most suitable for all of the viewers from the program list 18.

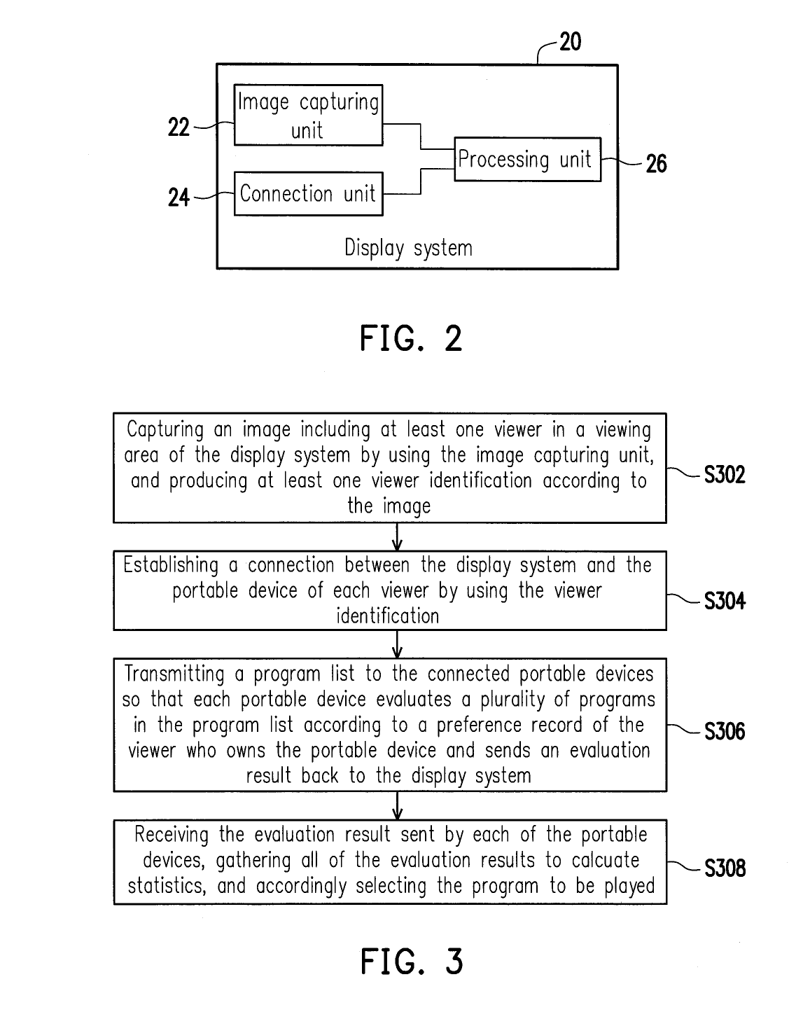

FIG. 2 is a block diagram illustrating a display system 20 according to an embodiment of the invention. Referring to FIG. 2, a display system 20 of the present embodiment is a media player, such as a multimedia on demand (MOD) player, a video on demand (VOD) player, or a set top box (STB), connected to a television or a display, but the invention is not limited thereto. The display system 20 includes an image capturing unit 22, a connection unit 24 and a processing unit 26, and functions thereof are described as follows.

The image capturing unit 22 is, for example, disposed in or around the display system 20, and configured to capture an image in a viewing area of the display system 20. The image capturing unit 22 includes a lens, a shutter, an optical sensing element, and other components. The optical sensing element is, for example, a charge coupled device (CCD), a complementary metal-oxide semiconductor (CMOS) device or other devices. When a shutter signal is received by the image capturing unit 22, the image in the viewing area of the display system 20 is then captured.

The connection unit 24 is, for example, a wireless connection device that supports protocols such as wireless fidelity (Wi-Fi), worldwide interoperability for microwave access (WiMAX), bluetooth or radio-frequency identification (RFID), and adapted to establish a wireless connection with the portable devices of the viewers nearby in a manner of wireless transmission. On the other hand, the connection unit 24 may also be devices having interfaces such as universal serial bus (USB), or network interface card (NIC), and adapted to establish a wired connection with the portable devices of the viewers through connecting cables. Aforesaid connecting methods between the connection unit 24 and the portable device are merely examples, and the invention is not limited thereto.

The processing unit 26 is coupled to the image capturing unit 22 and the connection unit 24. The processing unit 26 may be, for example, a central processing unit (CPU) with single-core or multi-core, or other programmable devices for general purpose or special purpose such as a microprocessor and a digital signal processor (DSP), a programmable controller, an application specific integrated circuit (ASIC) or other similar components or a combination of above-mentioned components. In the present embodiment, the processing unit 26 may execute computer programs to realize the program selection method according to the embodiments of the invention.

To be specific, FIG. 3 is a flowchart illustrating the program selection method according to an embodiment of the invention. Referring to FIG. 2 and FIG. 3 together, the method of the present embodiment is suitable for said display system 20, and detailed steps in the method of the present embodiment are described below with reference to each component of the display system 20 in FIG. 2.

First, the processing unit 26 controls the image capturing unit 22 to capture an image including at least one viewer in a viewing area of the display system 20, and accordingly produce at least one viewer identification (step S302). The viewer identification is, for example, a personal image of each of the viewers or characteristic information of the personal image of each of the viewers obtained through a digitized analysis. To be specific, in an embodiment, the processing unit 26 may, for example, identify each of the viewers included in the image captured by the image capturing unit 22 by using face recognition, and capture the personal image of each of the viewers to serve as the viewer identification. In another embodiment, the processing unit 26 may, for example, analyze the image captured by the image capturing unit 22 for obtaining the characteristic information of each viewer included in the image to serve as the viewer identification.

Next, the processing unit 26 may, for example, attempt to establish a connection with the portable devices around the display system 20 through the connection unit 24. The processing unit 26 establishes the connections with the portable device of each viewer included in the viewing area of the display system 20 by using the viewer identifications (step S304). The processing unit 26 may, for example, establish the connection with the portable device of each viewer through the connection unit 24 in the wired or wireless manner, and said connection methods have been described in the foregoing embodiment, thus not being repeated herein. Further, in the present embodiment, the connection between the display system 20 and the portable device of each of the viewers is established by performing a verification using the viewer identification, and such verification may be implemented on the portable device or on the display system 20, which is not particularly limited by the invention.

To be specific, in an embodiment, the processing unit 26 may, for example, transmit the viewer identification to each of the portable devices through the connection unit 24, and each of the portable devices may perform a verification to verify the received viewer identification with the viewer identification of its own. If the verification is passed, the connection between the display system 20 and the portable device may then be established. The viewer identification of each of the portable devices is established by the viewer who owns the portable device. In the display system 20, an automatic capturing method is adopted to perform the verification on the viewer identification of each of the portable devices in the same scene, so as to ensure that the viewer who owns the portable device to which the connection is established with is the viewer in the viewing area of the display system 20.

Further, in another embodiment, the processing unit 26 may, for example, receive the viewer identification provided by each of the portable devices nearby through the connection unit 24, and perform a verification to verify the received viewer identification with the viewer identification which is produced previously. If the verification is passed, the connection between the display system 20 and the portable device is then established. Similar to the foregoing embodiment, in the present embodiment, by performing the verification on the viewer identification of each of the portable devices in the same scene, it can also ensure that the viewer who owns the portable device to which the connection is established with is the viewer in the viewing area of the display system 20.

Returning back to the flowchart of FIG. 3, after the connection between the display system 20 and the portable device of the viewer is established, the processing unit 26 may transmit a program list including programs which are currently playable to each of the portable devices through the connection unit 24, and each of the portable devices may evaluate a plurality of programs in the program list according to a preference record of the viewer who owns the portable device, and send an evaluation result back to the display system 20 after the evaluation is completed (step S306). Therein, a personal preference database of the viewer is, for example, established in advance in each of the portable devices, and a plurality of entertainment categories and a preference strength of each of the entertainment categories are, for example, recorded in the personal preference database. When an application installed in the portable device is used, the media information stored in the portable device is accessed or data in the personal preference database is used by the viewer, the portable device may update the preference strength of each of the entertainment categories in the personal preference database according to information such as a usage record of the application, an access record of the media information, or a usage record of the personal preference database.

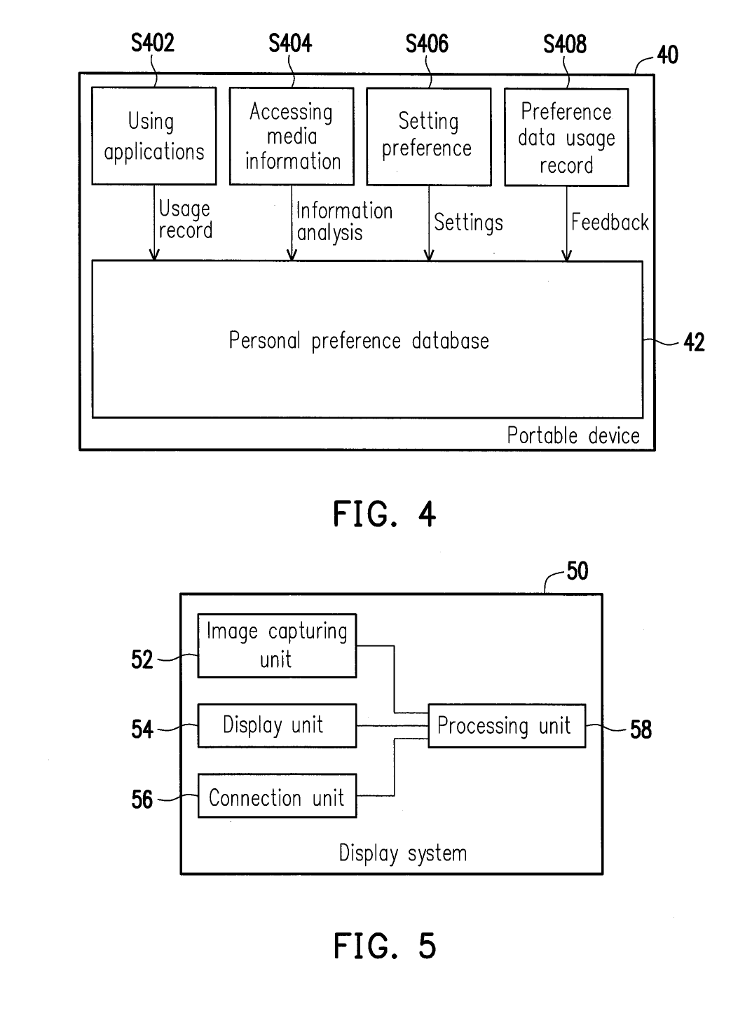

For instance, FIG. 4 is a schematic diagram illustrating establishment of the personal preference database according to an embodiment of the invention. Referring to FIG. 4, in the present embodiment, a personal preference database 42 of the viewer is, for example, established in a portable device 40, and a plurality of methods are provided to update the personal preference database 42. The personal preference database 42 is categorized according to common entertainment information such as food, music, movie, sociality, sport, or travel, and the preference strength of the viewer for said categories are respectively recorded. When the viewer uses the applications built-in the portable device 40, in correspondence to the usage record of the applications, the portable device 40 may update the preference strength of the category related to the usage record in the personal preference database 42 (step S402); when the viewer uses the portable device 40 to access the media information, the portable device 40 may, for example, analyze a file characteristic of the media information being accessed, so as to update the preference strength of the category related to the media information in the personal preference database 42 (step S404); when the viewer directly sets a preference in an operating interface of the preference setting, the portable device 40 may update the preference strength of the category set by the viewer in the personal preference database 42 (step S406); and when preference data in the personal preference database 42 is used by the portable device 40, the portable device 40 may feedback a usage record of the preference data to the personal preference database 42, so as to update the preference strength of the category related to the preference data being used (step S408). By using above-said updating methods, a precision of the preference data may be effectively improved.

Returning back the flowchart of FIG. 3, the processing unit 26 may receive an evaluation result for the program list sent by each of the portable devices through the connection unit 24, collect all of the evaluation results to calculate statistics, and accordingly selects the program to be played (step S308). The processing unit 26 may integrate all of the evaluations sent from the viewers in the same scene, so as to obtain the evaluation result that integrates the preferences of all of the viewers. In an embodiment, the processing unit 26 may automatically select the program with a highest preference from the evaluation results and automatically play the program. In another embodiment, the processing unit 26 may sort all of the programs according to an evaluation score for each of the programs, and provide a recommendation list including the sorted programs for the viewers to select.

By using above-said methods, the display system 20 according to the embodiments of the invention is capable of smartly selecting the program which matches of the preferences of all of the viewers on the scene and playing the program for the viewers. Moreover, because the evaluations for the programs are performed on the portable device of the viewer, the viewer is able to retain personal privacy without directly disclosing personal preferences. In addition, all steps in the method in the embodiments of the invention may be performed automatically, and thus complex processes of evaluation and selection for the programs may be omitted, so as to provide the viewers with an easier and more intuitive program viewing experience.

It should be noted that, in yet another embodiment, said display system may also be integrated in a television or a display, so as to simultaneously provide functions of playing and displaying the programs. Another embodiment is given for illustration below.

FIG. 5 is a block diagram illustrating a display system 50 according to an embodiment of the invention. Referring to FIG. 5, in the present embodiment, a display system 50 is, for example, a smart television or a display, which includes an image capturing unit 52, a display unit 54, a connection unit 56 and a processing unit 56. Therein, the image capturing unit 52, the connection unit 56 and the processing unit 58 are respectively identical or similar to the image capturing unit 22, the connection unit 24 and the processing unit 26 of FIG. 2, and thus detailed descriptions are omitted hereinafter.

Unlike the foregoing embodiment, in the present embodiment, the display system 50 further includes the display unit 54. The display unit 54 is, for example, a liquid-crystal display (LCD), a plasma display (PDP), a vacuum fluorescent display, a light-emitting diode (LED) display, a field emission display (FED) and/or other appropriate displays. The display unit 54 is coupled to the processing unit 58 and capable of displaying frames of the program selected by the processing unit 58.

In summary, the display system and the program selection method thereof in the invention is capable of establishing the connections with the portable devices of all of the viewers in the scene through image recognition, so that each of the portable devices may evaluate the currently-playable programs of the display system according to the personal preference database established in advance. After integrating the evaluation results sent from all of the viewers, the display system may select the program which is most suitable for all of the viewers. Because the personal preference is recorded in the portable device of the viewer, the privacy of the viewer can be ensured. Furthermore, through this evaluation mechanism, the viewer is able to watch the program matching his/her own preference on different televisions at different places.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A program selection method, adapted for a display system having an image capturing unit, comprising:
capturing an image including at least one viewer in a viewing area of the display system by using the image capturing unit, and producing at least one viewer identification according to the image;
establishing a connection between the display system and a portable device of each viewer by using the viewer identification;
transmitting a program list to the connected portable devices, and each of the portable devices evaluating a plurality of programs in the program list according to a preference record of the viewer who owns the portable device and sending an evaluation result back to the display system; and
receiving the evaluation result sent by each of the portable devices, gathering all of the evaluation results to calculate statistics, and accordingly selecting the program to be played.

2. The program selection method of claim 1, wherein the step of producing the at least one viewer identification according to the image comprises:
identifying each of the viewers included in the image, and capturing a personal image of each of the viewers to serve as the viewer identification.

3. The program selection method of claim 1, wherein the step of producing the at least one viewer identification according to the image comprises:
analyzing the image for obtaining characteristic information of each of the viewers included in the image to serve as the viewer identification.

4. The program selection method of claim 1, wherein the step of establishing the connection between the display system and the portable device of each viewer by using the viewer identification comprises:
transmitting the viewer identification to each of the portable devices, and each of the portable devices performing a verification to verify the received viewer identification with the viewer identification of the portable device and establishing the connection with the display system if the verification is passed.

5. The program selection method of claim 1, wherein the step of establishing the connection between the display system and the portable device of each viewer by using the viewer identification comprises:
receiving the viewer identification provided by each of the portable devices, performing a verification to verify the received viewer identification with the viewer identification produced previously, and establishing the connection with the portable device if the verification is passed.

6. The program selection method of claim 1, wherein before the step of each of the portable devices evaluating the programs in the program list according to the preference record of the viewer who owns the portable device, the method further comprises:
each of the portable devices establishing a personal preference database of the viewer who owns the portable device, and the personal preference database recording a plurality of entertainment categories and a preference strength of each of the entertainment categories; and
the portable device updating the preference strength of each of the entertainment categories according to a record of the viewer using application on the portable device, a record of the viewer accessing media information on the portable device, and a usage record of the personal preference database.

7. The program selection method of claim 6, wherein the step of the portable device updating the preference strength of each of the entertainment categories according to the record of the viewer accessing the media information on the portable device comprises:
analyzing a file characteristic of the accessed media information, and updating the preference strength of each of the entertainment categories according to the file characteristic.

8. The program selection method of claim 1, wherein the step of gathering all of the evaluation results to calculate statistics, and accordingly selecting the program to be played comprises:
sorting the programs according to an evaluation score of each of the programs, and providing a recommendation list including the sorted programs.

9. A display system, comprising:
an image capturing unit, capturing an image including at least one viewer in a viewing area of the display system;
a connection unit, establishing a connection between the display system and a portable device of each viewer; and
a processing unit, coupled to the display unit, the image capturing unit and the connection unit, producing at least one viewer identification according to the image captured by the image capturing unit, establishing the connection between the display system and each portable device through the connection unit by using the viewer identification, transmitting a program list to the connected portable devices, and receiving an evaluation result for the program list sent by each of the portable devices, gathering all of the evaluation results to calculate statistics, and accordingly selecting the program to be played.

10. The display system of claim 9, further comprising:
a display unit, coupled to the processing unit, displaying the program selected by the processing unit.

11. The display system of claim 9, wherein the processing unit comprises identifying each of the viewers included in the image captured by the image capturing unit, and capturing a personal image of each of the viewers to serve as the viewer identification.

12. The display system of claim 9, wherein the processing unit comprises analyzing the image captured by the image capturing unit for obtaining characteristic information of each of the viewers included in the image to serve as the viewer identification.

13. The display system of claim 9, wherein the processing unit comprises transmitting the viewer identification to each of the portable devices through the connection unit, wherein each of the portable devices performs a verification to verify the received viewer identification with the viewer identification of the portable device and establishes the connection with the display system if the verification is passed.

14. The display system of claim 9, wherein the processing unit comprises receiving the viewer identification provided by each of the portable devices through the connection unit, performing a verification to verify the received viewer identification with the viewer identification produced previously, and establishing the connection with the portable device if the verification is passed.

15. The display system of claim 9, wherein when the program list transmitted by the display system is received, each of the portable devices evaluates a plurality of programs in the program list according to a preference record of the viewer who owns the portable device, and sends the evaluation result back to the display system.

16. The display system of claim 15, wherein each of the portable devices further establishes a personal preference database of the viewer who owns the portable device, wherein the personal preference database records a plurality of entertainment categories and a preference strength of each of the entertainment categories, and the portable device further updates the preference strength of each of the entertainment categories according to a record of the viewer using application on the portable device, a record of the viewer accessing media information on the portable device, and a usage record of the personal preference database.

17. The display system of claim 16, wherein each of the portable devices further analyzes a file characteristic of the accessed media information, and updates the preference strength of each of the entertainment categories according to the file characteristic.

18. The display system of claim 9, wherein the processing unit comprises sorting the programs according to an evaluation score of each of the programs, and providing a recommendation list including the sorted programs.
